(19) United States
(12) Patent Application Publication
(10) Pub. No.: US 2017/0355341 A1
(43) Pub. Date: Dec. 14, 2017

(54) AIRBAG CUSHIONS FOR ECCENTRIC STEERING WHEELS AND RELATED SYSTEMS AND METHODS

(71) Applicant: Autoliv ASP, Inc., Ogden, UT (US)

(72) Inventors: David Keyser, Orion, MI (US); Donald James Paxton, Romeo, MI (US)

(21) Appl. No.: 15/178,295

(22) Filed: Jun. 9, 2016

(51) Int. Cl. B60R 21/203; B60R 21/2338

(52) U.S. Cl. CPC B60R 21/203; B60R 21/2338

(57) ABSTRACT

Airbag cushion assemblies for anchoring an airbag cushion in a desired position during deployment. Some embodiments may be configured for use in connection with eccentric steering wheels, such as steering wheels lacking an upper rim portion. Some embodiments may comprise an airbag housing coupled with the steering wheel, an airbag cushion positioned in the airbag housing, and means for anchoring a portion of the airbag cushion to assist in preventing the airbag cushion from being pushed in a direction opposite to the missing steering wheel structural element relative to the steering wheel during deployment of the airbag cushion.

### SUMMARY

Certain eccentric steering wheel designs, such as, for example, steering wheels lacking an upper rim section, are becoming more common. However, driver-side airbag cushions may experience certain unique problems when being deployed from and/or adjacent to such steering wheels. For example, without the support provided by an upper rim section, airbag cushions may tend to shift upwards relative to the driver when contacted by the driver. This may be dangerous or otherwise undesirable.

The present inventors have therefore determined that it would be desirable to provide systems and methods that overcome one or more of the foregoing limitations and/or other limitations of the prior art. In some embodiments, the inventive concepts disclosed herein may be used to prevent an airbag cushion from shifting undesirably during deployment. For example, in some driver-side airbag embodiments, one or more features and/or elements may be provided for anchoring a lower portion of the airbag cushion or otherwise preventing the airbag cushion from being pushed upward relative to the steering wheel during deployment of the airbag cushion. This may be done by way of, for example, deployable and/or inflatable members, such as inflatable tubes, which may be configured to engage a portion of an eccentric steering wheel. Alternatively, one or more tethers may be provided to anchor the airbag cushion and thereby prevent, or at least inhibit, its movement upwards where it may not have the support of an upper steering wheel rim section.

Another example of an eccentric steering wheel design with which one or more of the embodiments and/or inventive concepts disclosed herein may be applicable is a steering wheel configured such that the airbag module and/or housing associated with the steering wheel is positioned flush with, or at least substantially flush with, the steering wheel such that there is essentially no supportive structure above the module/housing with which to contact the cushion during deployment. Thus, for purposes of this disclosure, a steering wheel “lacking an upper rim portion” or “lacking an upper rim section” should be construed to encompass a steering wheel lacking, or at least substantially lacking, a supportive structure positioned above the airbag module and/or housing from which the airbag cushion is deployed. However, those of ordinary skill in the art, after having received the benefit of this disclosure, will appreciate that these principles may be applied to other types of eccentric steering wheels lacking a supportive structure in other areas, such as along the bottom of the steering wheel and/or below the airbag housing.

In a more particular example of an airbag cushion assembly according to some embodiments, the assembly may comprise an airbag cushion configured to be deployed adjacent to a steering wheel; and a deployable steering wheel coupling member coupled with the airbag cushion, wherein the deployable steering wheel coupling member is configured to, upon deployment of the deployable steering wheel coupling member, engage an opening in the steering wheel to provide a force to assist in preventing the airbag cushion from shifting relative to the steering wheel during deployment of the airbag cushion.

In some embodiments, the deployable steering wheel coupling member may be configured to engage the opening so as to provide a downward force to the airbag cushion relative to the steering wheel to assist in preventing the airbag cushion from shifting upwards during deployment of the airbag cushion.

Some embodiments may further comprise a second deployable steering wheel coupling member configured to deploy with the deployable steering wheel coupling member. In some such embodiments, the second deployable steering wheel coupling member may be configured to engage a second opening in the steering wheel.

In some embodiments, the deployable steering wheel coupling member comprises an inflatable tube that may be configured to extend through the opening in the steering wheel upon deployment. In some such embodiments, the inflatable tube may comprise a knob at a terminal end of the inflatable tube. The knob may be configured to expand to a size and/or diameter greater than a size/diameter of the opening to assist in preventing the inflatable tube from being withdrawn from the opening after extending through the opening.

In some embodiments, the airbag cushion is configured to be deployed from within the steering wheel. Alternatively, the airbag cushion may be configured to be deployed adjacent to the steering wheel.

In some embodiments, the deployable steering wheel coupling member may be inflatable. In some such embodiments, the deployable steering wheel coupling member may be configured to be inflated using a single inflator also used for inflating the airbag cushion. Alternatively, the deployable steering wheel coupling member may have its own inflator.

Some embodiments may further comprise means for delaying deployment of the deployable steering wheel coupling member relative to the airbag cushion, such as a frictional strap coupled to the deployable steering wheel coupling member, a breakaway stitch, and/or a patch defining an opening through which a strap coupled to the deployable steering wheel coupling member may be received.

In another example of an airbag cushion assembly according to other embodiments, the assembly may comprise an airbag housing, which housing may comprise a primary section and a housing projection extending from the primary section. The assembly may further comprise an airbag cushion, which may be wholly or at least primarily positioned within the primary section. A strap may be positioned to at least partially extend within the housing projection. The strap may be coupled to the airbag cushion and may be configured to, upon deployment of the airbag cushion, assist in preventing the airbag cushion from shifting in a direction at least substantially opposite from the housing projection. The housing projection may comprise, for example, a projection that is narrower than the primary section and may project from the primary section in a direction to allow for receipt of the strap therethrough.

In some embodiments, at least a portion of the strap may be fixed within the housing projection. Thus, in some embodiments, the projection may only have dimensions sufficient to receive the strap and/or structural elements for fixing the strap therein.

Some embodiments may further comprise a pin positioned within the housing projection. In some such embodiments, a first end of the strap may extend around the pin and may be coupled to a rear portion of the airbag cushion adjacent to the pin. In some such embodiments, a second end of the strap opposite the first end may be coupled to a front portion of the airbag cushion.

In some embodiments, the strap may be coupled to the airbag cushion at a first end of the strap, and the strap may be coupled to a lower portion of the airbag cushion at a second end of the strap opposite the first end. In some such embodiments, the strap may be coupled to a central area of the airbag cushion at the first end.

In some embodiments, the housing projection may be configured to be positioned so as to define a spoke on a vehicle steering wheel. Such spoke may be structural or, alternatively, may only be considered a spoke for aesthetic purposes.

In an example of a vehicle according to some embodiments, the vehicle may comprise a steering wheel. The vehicle may comprise an airbag cushion assembly, comprising an airbag housing coupled with the steering wheel. In some embodiments, the steering wheel may comprise a side lacking, or substantially lacking, a structural element extending beyond the airbag housing. For example, in some embodiments the steering wheel may lack an upper rim portion. An airbag cushion may be positioned in the airbag housing. The assembly may further comprise means for anchoring a portion of the airbag cushion to assist in preventing the airbag cushion from being pushed in a direction opposite from a missing structural element of the steering wheel relative to the steering wheel during deployment of the airbag cushion.

In some embodiments, the means for anchoring may comprise means for anchoring a lower portion of the airbag cushion to assist in preventing the airbag cushion from being pushed upward relative to the steering wheel during deployment of the airbag cushion.

In some embodiments, the steering wheel may comprise at least one opening. In some such embodiments, the means for anchoring may comprise a deployable steering wheel coupling member coupled with the airbag cushion and configured to, upon deployment of the deployable steering wheel coupling member, engage the at least one opening in the steering wheel to provide a force to assist in preventing the airbag cushion from shifting in a direction opposite from the missing structural element of the steering wheel relative to the steering wheel during deployment of the airbag cushion.

In some embodiments, the means for anchoring may comprise a strap coupled to the airbag cushion. In some such embodiments, the strap may extend out of the airbag cushion and/or may be fixed at a lower region relative to the steering wheel.

In some embodiments, the airbag housing may comprise a primary section and a housing projection extending from the primary section. In some such embodiments, wherein the lower region may be within the housing projection such that at least a portion of the strap is fixed within the housing projection.

In some embodiments, the airbag housing may comprise an opening through which the strap extends. In some such embodiments, the strap may be fixed to the steering wheel.

The features, structures, steps, or characteristics disclosed herein in connection with one embodiment may be combined in any suitable manner in one or more alternative embodiments.

### BRIEF DESCRIPTION OF THE DRAWINGS

Non-limiting and non-exhaustive embodiments of the disclosure are described, including various embodiments of the disclosure with reference to the figures, in which:

FIGS. 1A-1C depict an airbag cushion assembly in various stages of deployment according to one embodiment;

FIG. 2 is a rear elevation view of the airbag cushion assembly depicted in FIG. 1;

FIG. 3 is a front elevation view of the airbag cushion assembly of FIG. 2;

FIG. 4 is a cross-sectional view taken along line 4-4 in FIG. 2;

FIGS. 5A-5C depict an airbag cushion assembly in various stages of deployment according to an alternative embodiment;

FIG. 6 is a perspective view of a patch for coupling a strap used in connection with a deployable steering wheel coupling member to an airbag cushion according to some embodiments;

FIG. 7 depicts an alternative embodiment of an airbag cushion assembly;

FIG. 8 is a front elevation view of the airbag cushion assembly of FIG. 1;

FIGS. 9A-9C depict an airbag cushion assembly in various stages of deployment according to another alternative embodiment; and

FIG. 10 is a perspective view of certain components of a still another embodiment of an airbag cushion assembly.

### DETAILED DESCRIPTION

A detailed description of apparatus, systems, and methods consistent with various embodiments of the present disclosure is provided below. While several embodiments are described, it should be understood that the disclosure is not limited to any of the specific embodiments disclosed, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

Apparatus, methods, and systems are disclosed herein relating to airbag cushion assemblies configured to anchor the airbag in a desired position during deployment. For example, certain preferred embodiments may be configured for use in connection with steering wheels lacking a support section in a particular area, such as an upper rim portion. Because such steering wheels may lack the support needed to prevent the adjacent airbag cushion from being shifted upwards by impact with a driver, various means for anchoring a lower portion of the airbag cushion to assist in preventing the airbag cushion from being pushed upward relative to the steering wheel during deployment of the airbag cushion may be provided, as disclosed herein, such as a deployable steering wheel coupling member coupled with the airbag cushion configured to, upon deployment of the deployable steering wheel coupling member, engage the at least one opening in the steering wheel to provide a force to assist in preventing the airbag cushion from shifting upward relative to the steering wheel during deployment of the airbag cushion. Another example of a means for anchoring comprises a strap coupled to the airbag cushion. This strap may be fixed at a lower region relative to the steering wheel and/or may be configured to extend out of the airbag cushion during deployment.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

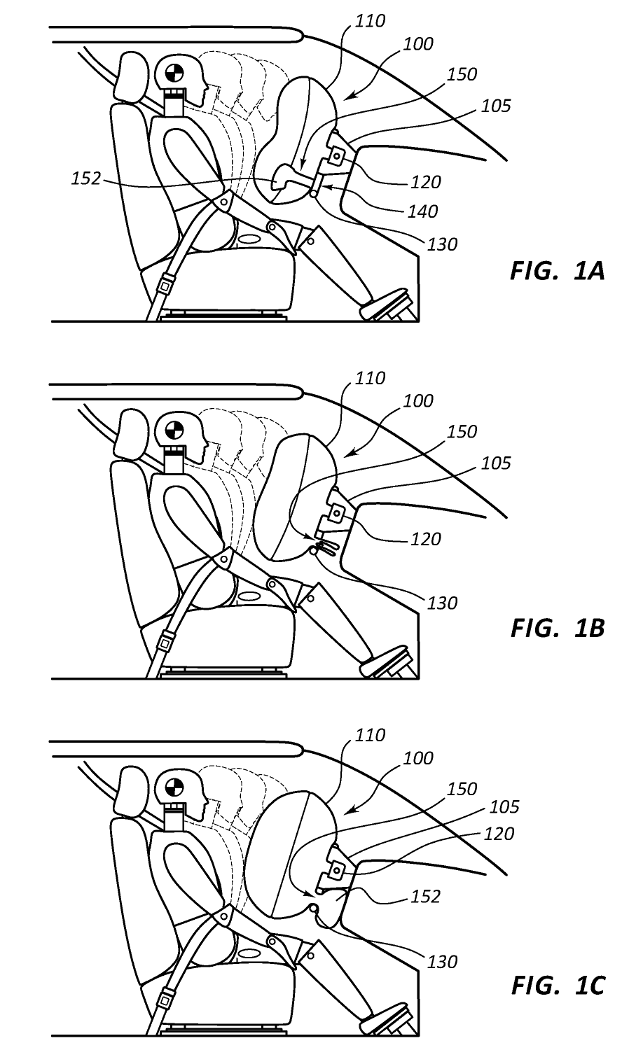

FIGS. 1A-1C depict the deployment of an airbag cushion assembly 100 according to some embodiments. Airbag cushion assembly 100 comprises an airbag cushion 110 being deployed from an airbag housing 105 comprising an inflator 120. Airbag housing 105 may be positioned within or adjacent to steering wheel 130 such that airbag cushion 110 is deployed adjacent to steering wheel 130. Steering wheel 130 comprises an eccentric steering wheel lacking an upper rim portion. Thus, there is essentially no supportive structure above airbag housing 105 for airbag cushion 110 to contact during deployment.

In order to prevent airbag cushion 110 from being shifted upwards during deployment, a deployable steering wheel coupling member 150 may be provided. Steering wheel coupling member 150 may comprise, for example, an inflatable tube positioned within airbag cushion 110. Deployable steering wheel coupling member 150 may be configured to, upon deployment, engage an opening 140 in steering wheel 130 to provide a force to assist in preventing the airbag cushion 110 from shifting relative to the steering wheel 130 during deployment of the airbag cushion 110.

As shown in FIG. 1A, deployable steering wheel coupling member 150 may be initially positioned within airbag cushion 110. In other words, in some preferred embodiments in which deployable steering wheel coupling member 150 comprises an inflatable tube, this tube may be inverted within airbag cushion 110 such that it may extend out from airbag cushion 110 during inflation of airbag cushion 110. However, alternative embodiments are contemplated in which deployable steering wheel coupling member 150 need not be inverted in this manner and still other embodiments are contemplated in which deployable steering wheel coupling member 150 need not be inflatable but may be deployed in another manner. Preferably, deployable steering wheel coupling member 150 is configured to remain within airbag cushion 110 during initial inflation of airbag cushion 110 and then, once airbag cushion 110 has been inflated to a desired position relative to steering wheel 130, may be configured to deploy so as to engage steering wheel 130.

Thus, as shown in FIG. 1B, once airbag cushion 110 has been inflated such that deployable steering wheel coupling member 150 is positioned adjacent to opening 140, deployable steering wheel coupling member 150 may be inflated such that it extends through opening 140 and, preferably, engages the structure of steering wheel 130 defining opening 140 so as to prevent, at least substantially prevent, or at least inhibit, airbag cushion 110 from being shifted upwards during deployment. For example, upon contacting a driver, the engagement between deployable steering wheel coupling member 150 and opening 140 may prevent the driver from forcing airbag cushion 110 above steering wheel 130. Thus, deployable steering wheel coupling member 150 may compensate for the lack of support that would have otherwise been provided by an upper rim portion on steering wheel 130.

FIG. 1C depicts airbag cushion assembly 100 following deployment of deployable steering wheel coupling member 150. As best seen in this figure, deployable steering wheel coupling member 150 may comprise a knob 152 at a terminal end of deployable steering wheel coupling member 150. Preferably, knob 152 is configured to expand to a size/diameter greater than a size/diameter of opening 140 to assist in preventing deployable steering wheel coupling member 150 from being withdrawn from opening 140. In some embodiments, knob 152 may be configured to expand to a size/diameter greater than the rest of steering wheel coupling member 150 but not necessarily than a size/diameter of opening 140.

Although knob 152 may be preferred for certain embodiments/uses, alternative embodiments are contemplated in which deployable steering wheel coupling member 150 may comprise alternative means for preventing steering wheel coupling member 150 from being withdrawn from opening 140 in steering wheel 130. For example, in some embodiments, steering wheel coupling member 150 may be made up of a different material than airbag cushion 110, such as a more rigid material that may provide sufficient rigidity to maintain airbag cushion 110 in a desired position with respect to steering wheel 130 during deployment. As another alternative, a hook-shaped feature may be formed at a terminal end of deployable steering wheel coupling member 150, which may be configured to engage a portion of steering wheel 130.

In some embodiments, deployable steering wheel coupling member 150 may be configured to be deployed from its own inflator, which may allow for delaying deployment relative to the airbag cushion, as mentioned above. Alternatively, the same inflator used to inflate airbag cushion 110 may be used to inflate deployable steering wheel coupling member 150. In some such embodiments, means for delaying deployment of the deployable steering wheel coupling member relative to the airbag cushion may be provided, as described in greater detail below. As also described below, in some embodiments, multiple deployable steering wheel coupling members may be provided. In some such embodiments, each of the various deployable steering wheel coupling members may be configured to couple with a different opening and/or structure of a steering wheel.

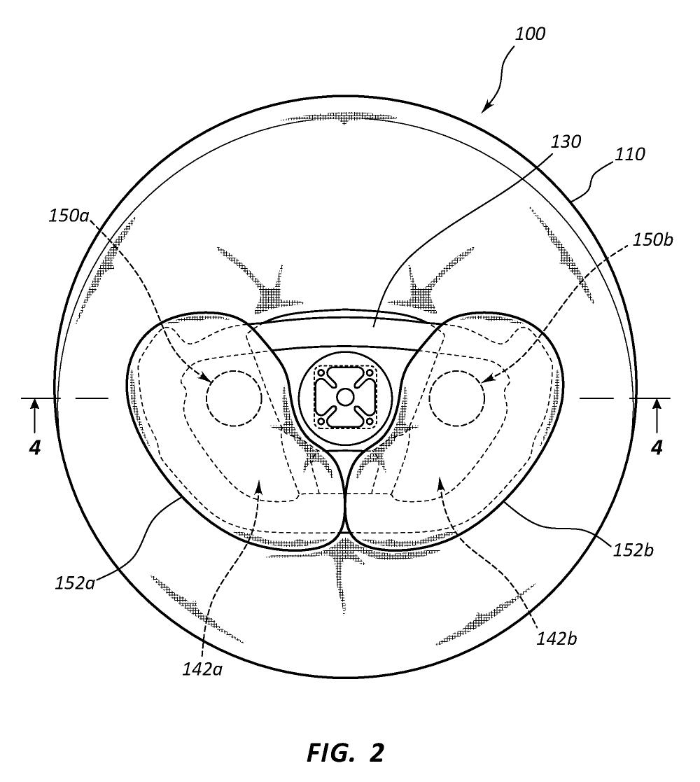

FIG. 2 is a rear elevation view of airbag cushion assembly 100 following deployment that illustrates how a plurality of steering wheel coupling members may be used. More particularly, airbag cushion assembly 100 may comprise a first deployable steering wheel coupling member 150a configured to extend through and engage a first opening 142a of steering wheel 130 and a second deployable steering wheel coupling member 150b configured to extend through and engage a second opening 142b of steering wheel 130. As also shown in FIG. 2, each of the deployable steering wheel coupling members 150a/150b may comprise a respective knob 152a/152b at its respective terminal end to assist in preventing them from being withdrawn from its respective steering wheel opening 142a/142b during deployment.

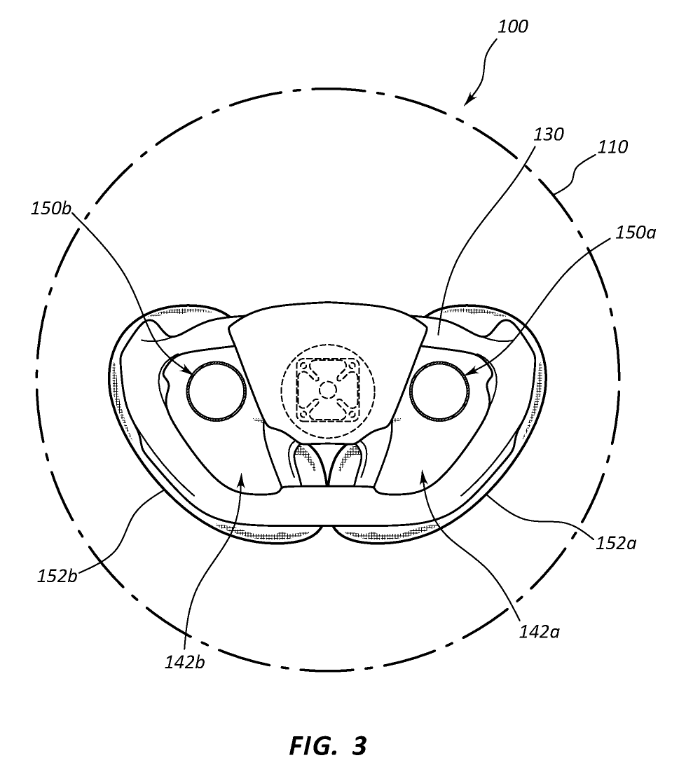

FIG. 3 is a front elevation view of airbag cushion assembly 100 following deployment. As can be seen from comparing FIGS. 2 and 3, in some embodiments, the deployable steering wheel coupling member(s) may be configured to have a smaller diameter/dimension, which may extend along most of the length of the deployable steering wheel coupling member(s), and then have a knob at the terminal end that is larger than the smaller diameter/dimension. An example of this smaller diameter is best seen in FIG. 3. The knob(s) may simply be a symmetrical shape, such as a frusto-spherical shape, that may be larger than the smaller diameter/dimension. Alternatively, as depicted in FIGS. 2 and 3, knob(s) may have an asymmetrical shape, which shape may match, or at least substantially match, the shape of their corresponding steering wheel opening.

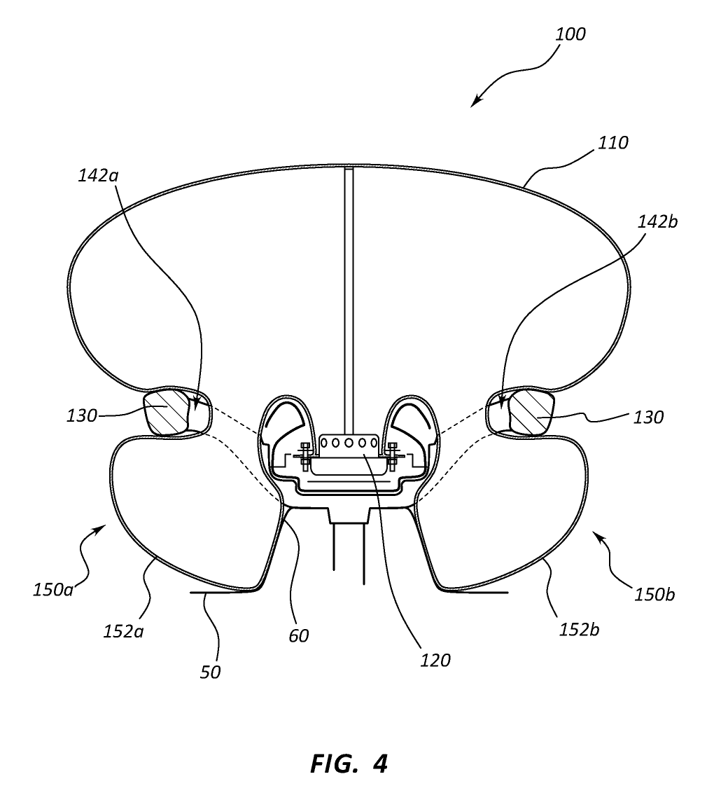

FIG. 4 is a cross-sectional view of airbag cushion assembly 100 following deployment. This figure illustrates how knobs 152a/152b may be deployed so as to engage a portion of steering wheel 130 defining openings 142a/142b and also a portion of another adjacent structure, such as an instrument panel 50 and/or steering column 60. However, other embodiments are contemplated in which one or more knobs and/or deployable steering wheel coupling members may be configured to only engage a portion of a steering wheel defining a steering wheel opening, or may be configured to otherwise engage a steering wheel or other structure, as described below.

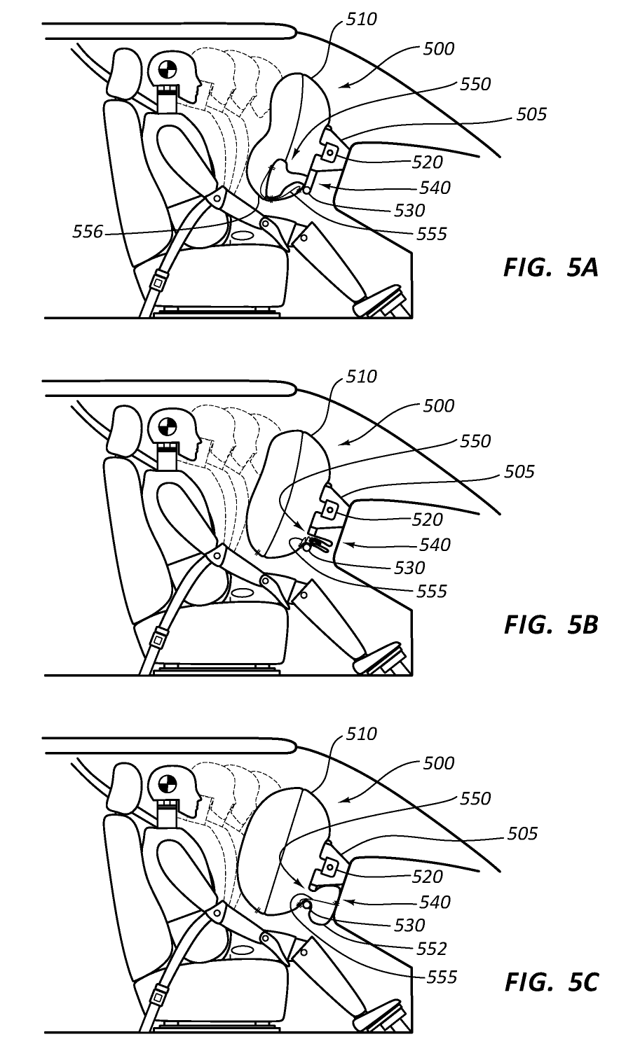

FIGS. 5A-5C depict the deployment of an airbag cushion assembly 500 according to other embodiments. Airbag cushion assembly 500, like airbag cushion assembly 100, comprises an airbag cushion 510 being deployed from an airbag housing 505 comprising an inflator 520. Airbag housing 505 may be positioned within or adjacent to steering wheel 530 such that airbag cushion 510 is deployed adjacent to steering wheel 530. Steering wheel 530 again comprises an eccentric steering wheel lacking an upper rim portion.

Airbag cushion assembly 500 also comprises a deployable steering wheel coupling member 550 having a knob 552 at its terminal end that is configured to extend through and engage an opening 540 formed within steering wheel 530 to provide a force to assist in preventing the airbag cushion 510 from shifting relative to the steering wheel 530 during deployment. However, airbag cushion assembly 500 differs from airbag cushion assembly 100 in that airbag cushion assembly 500 further comprises a strap 555 that is coupled to the deployable steering wheel coupling member 550. Strap 555 is one example of a means for delaying deployment of deployable steering wheel coupling member 550 relative to airbag cushion 510.

In some embodiments, strap 555 may comprise a frictional strap. In other words, strap 555 may comprise or be coated with a material configured to frictionally engage an internal surface of airbag cushion 510 to allow for desirably delaying deployment of deployable steering wheel coupling member 550 until airbag cushion 510 is in a proper position with respect to steering wheel 530 to allow deployable steering wheel coupling member 550 to enter opening 540. In some embodiments, strap 555 may comprise a woven material that may enhance the friction of the strap 555 to delay deployment. In some embodiments, a portion of the internal surface of airbag cushion 510 may also, or alternatively, be coated or otherwise provided with such a frictional coupling.

In other embodiments, a breakaway stitch 556 may be applied to deployable steering wheel coupling member 550 and/or strap 555 such that, upon inflation of airbag cushion 510 to a particular pressure, the breakaway stitch may be configured to sever to allow the deployable steering wheel coupling member 550 to deploy. Breakaway stitch 556 may, in some embodiments, extend through deployable steering wheel coupling member 550 and through a portion of airbag cushion 510, as shown in FIG. 5A, may extend through strap 555 and through a portion of airbag cushion 510, or may extend through deployable steering wheel coupling member 550, airbag cushion 510, and strap 555. Of course, multiple breakaway stitches in different locations and/or through different elements may be used to tune the deployment characteristics as desired.

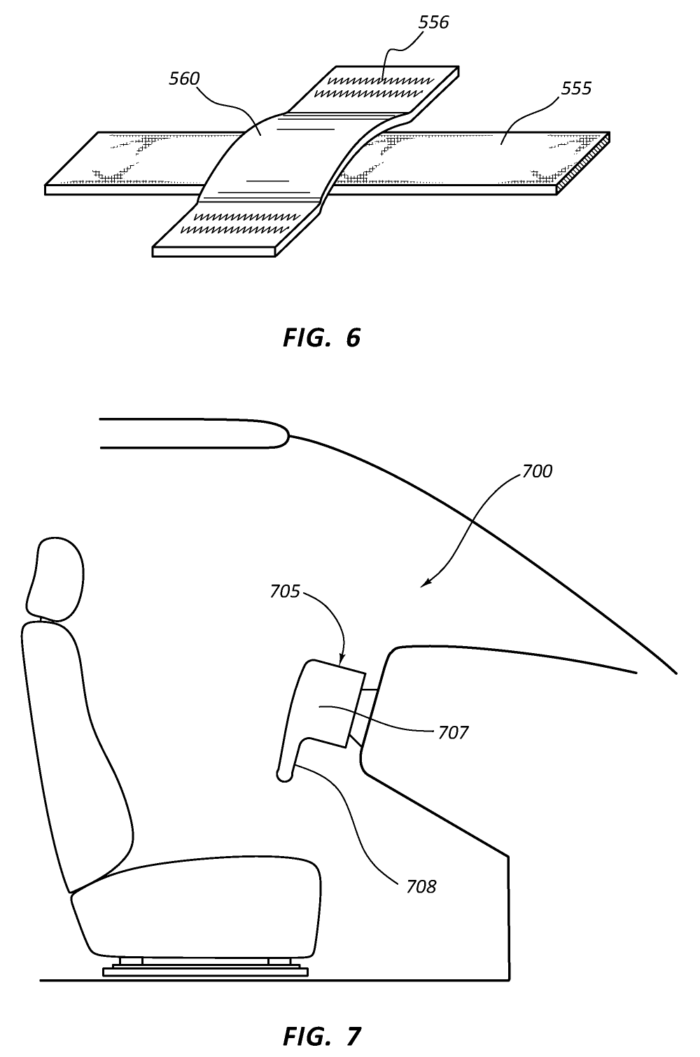

In other embodiments, a patch may be provided that defines an opening through which strap 555 may extend. For example, FIG. 6 depicts a patch 560 that may be applied to an internal surface of airbag cushion 510. In some embodiments, one or more tack stitches may be combined with a patch. For example, in the embodiment depicted in FIG. 6, one or both sides of patch 560 defining the opening through which strap 555 extends may be coupled with airbag cushion 510 by way of a breakaway stitch 556 such that, upon receipt of a predetermined force, which may correspond with a predetermined pressure within airbag cushion 510, patch 560 may be released to allow for deployment of deployable steering wheel coupling member 550 at a desired time during deployment of airbag cushion 510 and/or position of airbag cushion 510 with respect to steering wheel 530.

Alternatively, patch 560 may be permanently coupled at opposing ends and may comprise a material configured to provide sufficient friction to delay deployment of deployable steering wheel coupling member 550 relative to airbag cushion 510. In addition to, or as an alternative to, the material used for patch 560, patch 560 may be configured to delay deployment of deployable steering wheel coupling member 550 relative to airbag cushion 510 by being coupled to airbag cushion 510 in such a way that the opening created by patch 560 is sufficiently small/tight to create such friction with strap 555 extending therethrough.

Although the breakaway stitch 556 and deployable steering wheel coupling member 550 are depicted coupled to an internal surface of airbag cushion 550, in some embodiments, the breakaway stitch 556 and/or deployable steering wheel coupling member 550 may instead be coupled to an exterior surface of airbag cushion 550. Similarly, patch 560 may be coupled to an exterior surface of airbag cushion 550 in certain embodiments.

In some embodiments, one or more layers of airbag cushion 510 may be positioned to extend through patch 560 along with strap 555. Such layers, possibly in combination with adjustment of the width of patch 560, the material of patch 560, and or the size of the opening defined by patch 560, may allow for tuning the friction and/or the delay of deployment of deployable steering wheel coupling member 550 relative to airbag cushion 510.

In some embodiments in which the deployable steering wheel coupling member 550 comprises a knob 552, the breakaway stitch 556 may extend through the knob 552. Because inflation of knob 552 prior to deployable steering wheel coupling member 550 extending through opening 540 may prevent or at least inhibit deployable steering wheel coupling member 550 from fully extending through opening 540, specifically coupling breakaway stitch 556 or another means for delaying deployment of deployable steering wheel coupling member 550 relative to airbag cushion 510 with knob 552 may prevent or at least inhibit premature inflation of at least knob 552 of deployable steering wheel coupling member 550.

Strap 555, breakaway stitch 556, and patch 560 are each examples of means for delaying deployment of a deployable steering wheel coupling member relative to an airbag cushion.

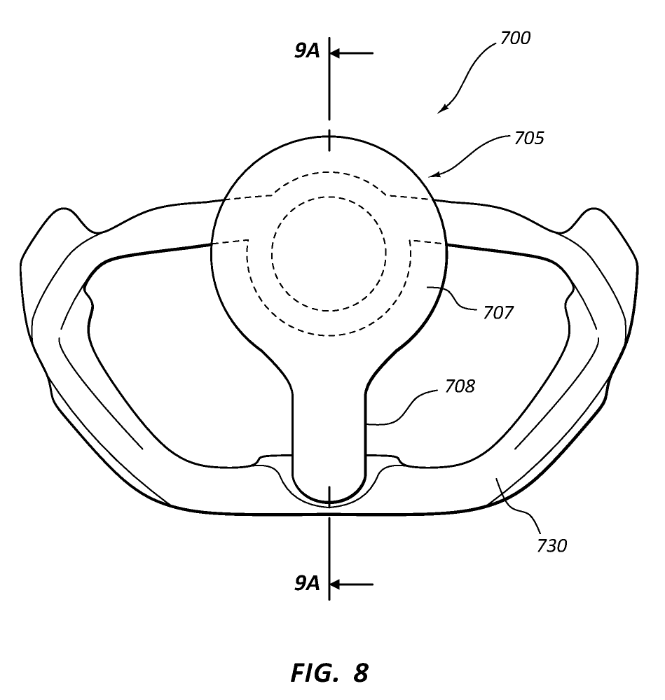

FIG. 7 illustrates yet another embodiment of an airbag cushion assembly 700 shown prior to deployment. As illustrated in this figure, airbag cushion assembly 700 comprises a housing 705 comprising a primary section 707 and a housing projection 708 extending from primary section 707.

In some embodiments, housing projection 708 may be configured to be positioned so as to define a spoke on a vehicle steering wheel. For example, as depicted in FIG. 8, airbag housing 705 may be positioned on an eccentric steering wheel 730 such that housing projection 708 defines a spoke on steering wheel 730. However, alternative embodiments are contemplated in which housing projection 708 may be positioned behind one of the spokes of the steering wheel 730 or otherwise need not form such a spoke. As also shown in FIG. 8, steering wheel 730 lacks an upper rim portion above the airbag housing 705 and, as previously mentioned, therefore lacks a structure that would otherwise typically be used to prevent the airbag cushion inside airbag housing 705 from being pushed upward relative to steering wheel 730 during deployment.

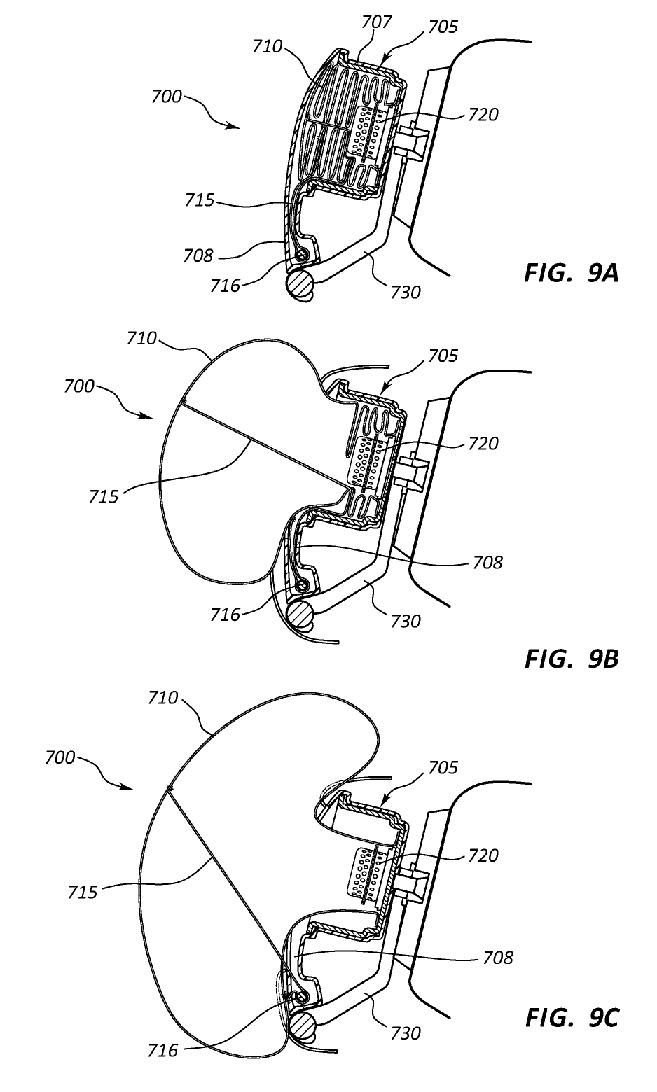

FIGS. 9A-9C depict various stages of deployment of airbag cushion assembly 700. As best seen in FIG. 9A, an airbag cushion 710 may be positioned within primary section 707 of airbag housing 705. In addition, a strap 715 is positioned to extend within housing projection 708. Strap 715 is coupled to airbag cushion 710, such as preferably at one end of strap 715 and is further coupled to a pin 716 fixedly positioned within housing projection 708. In other embodiments, strap 715 may be coupled to another fixed structure, either within airbag housing 705 or, as discussed in greater detail below, an external structure. Strap 715 is configured to, upon deployment of airbag cushion 710, assist in preventing airbag cushion 710 from shifting in a direction opposite from, or at least substantially opposite from, housing projection 708 so as to prevent airbag cushion 710 from being shifted above steering wheel 730.

The end of strap 715 opposite from the end coupled to an internal surface of the front of airbag cushion 710 may, after extending around pin 716, also be coupled to airbag cushion 710, such as to a rear portion of airbag cushion 710 (either internal or external). Preferably, strap 715 is coupled to a lower portion of airbag cushion 710 at the end opposite from the end coupled to the proximal or front portion of airbag cushion 710 to facilitate maintaining airbag cushion 710 in a desired position during inflation/deployment.

As shown in FIG. 9B, once inflator 720 has been initiated, inflation gas causes airbag cushion 710 to inflate. As shown in FIG. 9C, once airbag cushion 710 has sufficiently inflated, strap 715 is pulled taut. Because strap 715 is fixed within housing projection 708, airbag cushion 710 is kept from shifting upwards relative to steering wheel 730 (and, when steering wheel 730 is in a forward configuration, also relative to the adjacent driver). Strap 715 may extend through an opening in airbag cushion 710 to allow it to be fixedly coupled within airbag housing 705. Thus, in some embodiments, the end of strap 715 opposite from the end coupled to the proximal or front portion of airbag cushion 710 may be sewn or otherwise coupled to an exterior surface of airbag cushion 710. In some embodiments, strap 715 may also be used as a tether typically used to restrain the forward motion of airbag cushion 710. Alternatively, a separate strap/tether may be used for that purpose and strap 715 may only be used to restrain airbag cushion 710 from undesirably shifting in an upward direction, as previously described.

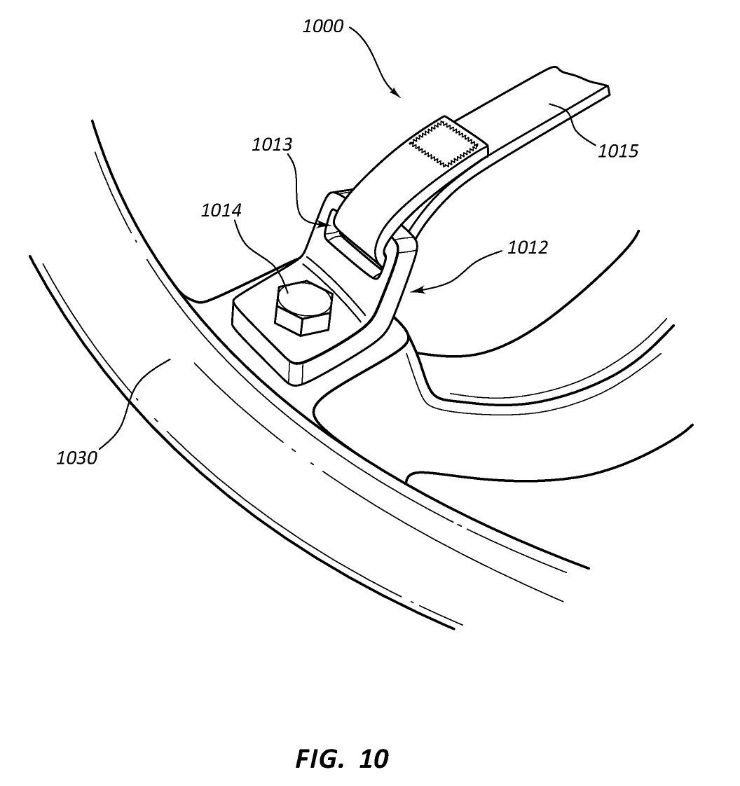

FIG. 10 depicts certain components of still another alternative embodiment of an airbag cushion assembly 1000. Other components of assembly 1000 not depicted in FIG. 10 may be similar to those previously described in connection with other embodiments and are not shown in FIG. 10 to avoid obscuring the disclosure. Assembly 1000 differs from the other embodiments previously described in that it comprises a strap 1015 that is coupled to steering wheel 1030 by way of a coupling member 1012. Coupling member 1012 may comprise an opening 1013 through which strap 1015 may extend and a fastener 1014, such as a bolt, screw, etc., that may be used to fasten coupling member 1012 to steering wheel 1030, preferably at a lower end/portion of steering wheel 1030.

Although not shown in FIG. 10, it should be understood that strap 1015 may extend through an opening formed within an airbag housing and/or through the airbag cushion positioned within the airbag housing. In addition, it should be understood that strap 1015 may be coupled at an opposite end to that shown in FIG. 10 to an internal surface of the airbag cushion. As shown in FIG. 10, strap 1015 may be coupled to coupling member 1012 by extending through opening 1013 and then being sewn or otherwise coupled with itself to form a secure connection. Because coupling member 1012 allows for coupling of strap 1015 to the steering wheel 1030 itself, airbag cushion assembly 1000 need not be formed with a housing projection, such as housing projection 708 of airbag cushion assembly 700.

Each of steering wheel coupling member 150, steering wheel coupling member 550, strap 715, pin 716, housing projection 708, strap 1015, and coupling member 1012 are examples of means for anchoring a portion of an airbag cushion to assist in preventing the airbag cushion from being pushed in a direction opposite from a missing structural element of a steering wheel relative to the steering wheel during deployment of the airbag cushion. When used in connection with a steering wheel lacking an upper rim portion, each of these structural elements also comprises means for anchoring a lower portion of an airbag cushion to assist in preventing the airbag cushion from being pushed upward relative to the steering wheel during deployment of the airbag cushion.

The foregoing specification has been described with reference to various embodiments and implementations. However, one of ordinary skill in the art will appreciate that various modifications and changes can be made without departing from the scope of the present disclosure. For example, various operational steps, as well as components for carrying out operational steps, may be implemented in various ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

Those having skill in the art will appreciate that many changes may be made to the details of the above-described embodiments without departing from the underlying principles of the invention. The scope of the present invention should, therefore, be determined only by the following claims.

1. An airbag cushion assembly, comprising:
an airbag cushion configured to be deployed adjacent to a steering wheel; and
a deployable steering wheel coupling member coupled with the airbag cushion, wherein the deployable steering wheel coupling member is configured to, upon deployment of the deployable steering wheel coupling member, engage an opening in the steering wheel to provide a force to assist in preventing the airbag cushion from shifting relative to the steering wheel during deployment of the airbag cushion.

2. The airbag cushion assembly of claim 1, wherein the deployable steering wheel coupling member is configured to engage the opening so as to provide a downward force to the airbag cushion relative to the steering wheel to assist in preventing the airbag cushion from shifting upwards during deployment of the airbag cushion.

3. The airbag cushion assembly of claim 1, further comprising a second deployable steering wheel coupling member configured to deploy with the deployable steering wheel coupling member, wherein the second deployable steering wheel coupling member is configured to engage a second opening in the steering wheel.

4. The airbag cushion assembly of claim 1, wherein the deployable steering wheel coupling member comprises an inflatable tube, and wherein the inflatable tube is configured to extend through the opening in the steering wheel upon deployment.

5. The airbag cushion assembly of claim 4, wherein the inflatable tube comprises a knob at a terminal end of the inflatable tube, wherein the knob is configured to expand to a diameter greater than a diameter of the opening to assist in preventing the inflatable tube from being withdrawn from the opening.

6. The airbag cushion assembly of claim 1, wherein the airbag cushion is configured to be deployed from the steering wheel.

7. The airbag cushion assembly of claim 1, wherein the deployable steering wheel coupling member is inflatable.

8. The airbag cushion assembly of claim 7, wherein the deployable steering wheel coupling member is configured to be inflated using a single inflator also used for inflating the airbag cushion.

9. The airbag cushion assembly of claim 1, further comprising means for delaying deployment of the deployable steering wheel coupling member relative to the airbag cushion.

10. The airbag cushion assembly of claim 9, wherein the means for delaying deployment comprises at least one of a frictional strap coupled to the deployable steering wheel coupling member, a breakaway stitch, and a patch defining an opening through which a strap coupled to the deployable steering wheel coupling member may be received.

11. An airbag cushion assembly, comprising:
an airbag housing comprising a primary section and a housing projection extending from the primary section;
an airbag cushion positioned within the primary section; and
a strap at least partially positioned within the housing projection, wherein the strap is coupled to the airbag cushion, and wherein the strap is configured to, upon deployment of the airbag cushion, assist in preventing the airbag cushion from shifting in a direction at least substantially opposite from the housing projection.

12. The airbag cushion assembly of claim 11, wherein at least a portion of the strap is fixed within the housing projection.

13. The airbag cushion assembly of claim 12, further comprising a pin positioned within the housing projection, wherein a first end of the strap extends around the pin and is coupled to a rear portion of the airbag cushion adjacent to the pin, and wherein a second end of the strap opposite the first end is coupled to a front portion of the airbag cushion.

14. The airbag cushion assembly of claim 11, wherein the strap is coupled to the airbag cushion at a first end of the strap, and wherein the strap is coupled to a lower portion of the airbag cushion at a second end of the strap opposite the first end.

15. The airbag cushion assembly of claim 14, wherein the strap is coupled to a central area of the airbag cushion at the first end.

16. The airbag cushion assembly of claim 11, wherein the housing projection is configured to be positioned so as to define a spoke on a vehicle steering wheel.

17. A vehicle, comprising:
a steering wheel;
an airbag cushion assembly, comprising:
an airbag housing coupled with the steering wheel;
an airbag cushion positioned in the airbag housing; and
means for anchoring a portion of the airbag cushion to assist in preventing the airbag cushion from being pushed in a direction opposite from a missing structural element of the steering wheel relative to the steering wheel during deployment of the airbag cushion.

18. The vehicle of claim 17, wherein the steering wheel lacks an upper rim portion above the airbag housing.

19. The vehicle of claim 18, wherein the means for anchoring comprises means for anchoring a lower portion of the airbag cushion to assist in preventing the airbag cushion from being pushed upward relative to the steering wheel during deployment of the airbag cushion

20. The vehicle of claim 17, wherein the steering wheel comprises at least one opening, and wherein the means for anchoring comprises a deployable steering wheel coupling member coupled with the airbag cushion, wherein the deployable steering wheel coupling member is configured to, upon deployment of the deployable steering wheel coupling member, engage the at least one opening in the steering wheel to provide a force to assist in preventing the airbag cushion from shifting in a direction opposite from the missing structural element of the steering wheel relative to the steering wheel during deployment of the airbag cushion.

21. The vehicle of claim 17, wherein the means for anchoring comprises a strap coupled to the airbag cushion, wherein the strap extends out of the airbag cushion and is fixed at a lower region relative to the steering wheel.

22. The vehicle of claim 21, wherein the airbag housing comprises a primary section and a housing projection extending from the primary section, and wherein the lower region is positioned in the housing projection such that at least a portion of the strap is fixed within the housing projection.

23. The vehicle of claim 21, wherein the airbag housing comprises an opening through which the strap extends, and wherein the strap is fixed to the steering wheel.
